(19) United States
(12) Patent Application Publication
(10) Pub. No.: US 2007/0013534 A1
(43) Pub. Date: Jan. 18, 2007

(54) Detection device for air filter

(76) Inventor: Edward G. DiMaggio, Hammond, LA (US)

Correspondence Address: KEATY PROFESSIONAL LAW CORPORATION;THOMAS S. KEATY, 2 CANAL STREET, 2140 WORLD TRADE CENTER, NEW ORLEANS, LA, 70130, US

(21) Appl. No.: 11/480,649

(22) Filed: Jul. 5, 2006

Related U.S. Application Data
(63) Continuation-in-part of application No. 10/942,694, filed on Sep. 16, 2004, now abandoned.

(51) Int. Cl. G08B 21/00

(52) U.S. Cl. 340/607

(57) ABSTRACT

A wireless sensor unit detects an out-of-range condition of an air filter in a HVAC system by sensing the air flow passing across the filter or by pressure differential across the air filter. A The sensor unit sends a signal to a receiver unit that can be positioned a distance from the sensor unit to process the signal sent by the sensor unit and provide audio and/or visual warning of the air filter condition.

### CROSS-REFERENCE TO RELATED APPLICATIONS

This application is a continuation-in-part of my co-pending application Ser. No. 10/942,694 filed on Sep. 16, 2004 for “Warning Device for Clogged Air Filters”, the full disclosure of which is incorporated by reference herein and the priority of which is hereby claimed.

### BACKGROUND OF THE INVENTION

This invention relates to an air filtration system and, more particularly to a device for detecting clogged condition of the air filter and for generating a warning signal when such condition is detected.

Heat and ventilation systems, commonly known as HVAC systems, are equipped with air permeable filters that are placed in a special opening connected to a return air duct. Conventional air filters comprise a frame made of sturdy plastic or metal, within which a porous, air permeable membrane is secured. The filters are placed in the path of the airflow of the air circulating system for preventing dust and other impurities from reaching the HVAC system. With time, the filter may become clogged with dust, dirt, and other such particles thereby restricting the airflow through the air return system. The reduction in the airflow on the downstream of the filter causes the fan placed in the direct path of the airflow to overload and overheat, which can ultimately lead to the damage of the HVAC system motor. Replacement of the motor can be very expensive and as a result, the building owners are encouraged to regularly replace or clean the air filters and to check the intake of the air conditioning system for icing or dirt accumulation.

However, visual inspection is tedious and time consuming, especially if the technician has to check multiple filters in an apartment building or an office building. The disadvantage of the visual inspection is that the technician or the homeowner may not properly detect the degree of clogging in the filter, thereby making it difficult to properly ascertain whether the full flow of air passes through the filter or if the air flow is greatly reduced due to the filter clogging.

The present invention contemplates elimination of drawbacks associated with conventional methods of visual detection of a clogged filter and provision of a simple and inexpensive device that can be incorporated with the existing air filtration systems and supplied as a separate unit for operation without intervention with a preinstalled HVAC system.

### SUMMARY OF THE INVENTION

It is therefore an object of the present invention to provide a device for detecting clogged conditions of the air filter in a HVAC system.

It is another object of the present invention to provide a warning device signaling reduction in the airflow on the downstream side of the filter.

A further object of the present invention is to provide a visual and audible warning device for signaling clogging of the air filter in a wireless operation.

These and other objects of present invention are achieved through a provision of a warning device that has a sensor unit positioned on the downstream side of the air filter, in the return air duct, and a receiver unit capable of receiving the signal generated by the sensor unit. The sensor unit has a sensor member that can detect an out-if-norm condition either through the reduction of the air flow across the filter or through a pressure sensitive member that detects pressure differential between the upstream side of the air filter and the downstream side of the air filter. The sensor unit has an antenna for sending the signal to the receiver unit, which is equipped with a receiving antenna. The receiver unit has a signal processor and audio/visual warning members for providing an audio and/or visual warning on the condition of the filter.

### BRIEF DESCRIPTION OF THE DRAWINGS

Reference will now be made to the drawings, wherein like parts are designated by like numerals and wherein

FIG. 1 is a schematic view of the air filter condition device in accordance with the present invention.

FIG. 2 is a detail view illustrating the sensor unit of the air filter condition device in accordance with the present invention.

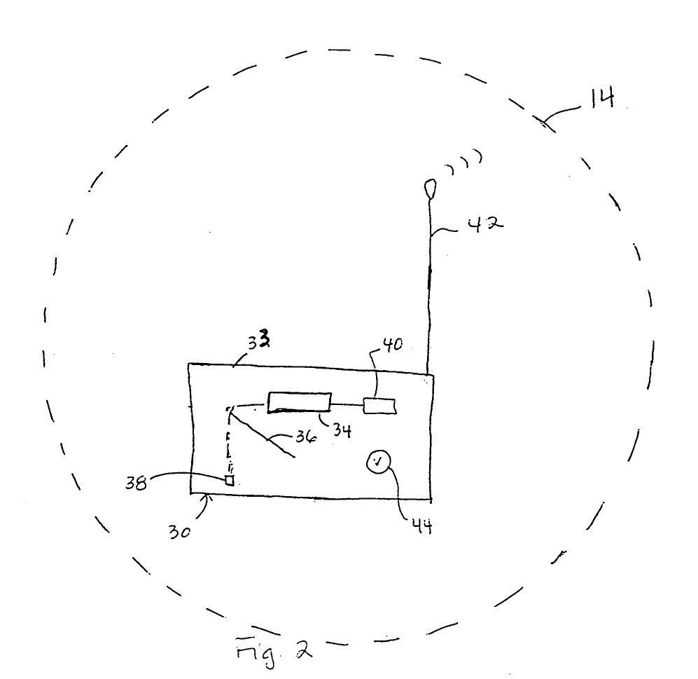

### DETAILED DESCRIPTION OF THE PREFERRED EMBODIMENT

Turning now to the drawings in more detail, numeral 10 designates an air filter of an HVAC system mounted in an opening 12 leading to a return air duct 14, which circulates air between an upstream side 16 of the air filter and a downstream side 18 of the air filter 10. The airflow, schematically illustrated by an arrow 20 passes across the membrane of the filter 10 before entering the air duct 14 and is then distributed through secondary conduits 22 to the rooms serviced by the HVAC system of the building.

With the passage of time, the air permeable material forming the air filter membrane becomes clogged with dust and other dirt particles sucked in from the upstream side 16. As a result, the amount of air delivered to the downstream side 18 is substantially reduced. To facilitate detection of the contamination of the air filter and reduction in the airflow, the present invention provides a warning device for detecting the clogged condition of the air filter in a conventional HVC system.

The warning device of the present invention comprises a sensor unit 30 positioned in the air duct 14 on the downstream side 18 of the air filter 10. The system also comprises a receiver unit 32 that can be positioned in any convenient place in the building, wherein the homeowner or the building owner is likely to see and/or hear the signals generated by the receiver unit 32.

The sensor unit 30 comprises a hollow housing 33, which houses a sensor member 34 therein. The sensor member 34 can be either a sensor that detects reduction in the airflow on the downside 18 of the filter 10 or alternatively an air pressure sensor that detects differences in pressure above a predetermined threshold between the upstream side 16 and the downstream side 18 of the air filter 10.

The sensor member 34 is electrically connected to a flapper 36 that activates a switch 38 positioned within the housing 33. The flapper 36 completes a circuit with the switch 38 when the clogged condition is detected. When the sensor member 34 detects the reduction in the airflow or out of range change of pressure on the downside 18 of the filter 10, the flapper 36 contacts the switch 38 and closes the electrical circuit. The sensor member then transmits a signal to a transmitter 40 mounted within the housing 38 for sending a wireless or radio signal through an antenna 42 alerting of the changed condition of the air filter. A battery 44 provides power for the operation of the sensor unit 32.

The sensor member 34 may be a sensitive pressure detection device that would work with the help of a membrane positioned inside the sensor 34. When at rest, some moderate air pressure on the membrane the circuitry in the housing 32 is detected as normal and not requiring a warning signal. However, should the sensor 34 detect an out-of-range change in pressure differential between the upstream side 16 and the downstream side 18 of the filter 10, the signal of the out-of-range condition is sent to the transmitter 40 and emitted by the through the antenna 42.

The signal of the out-of-range condition is received by the receiver unit 32, which has a housing 50 equipped with a receiving antenna 52. A processor 51 is mounted in the housing 50 in operational connection with the antenna 52 for processing the received signal. The processor 51 determines the type of the out-of-range condition that was detected by the sensor member 34 and the type of signal to be sent to other elements of the receiver unit.

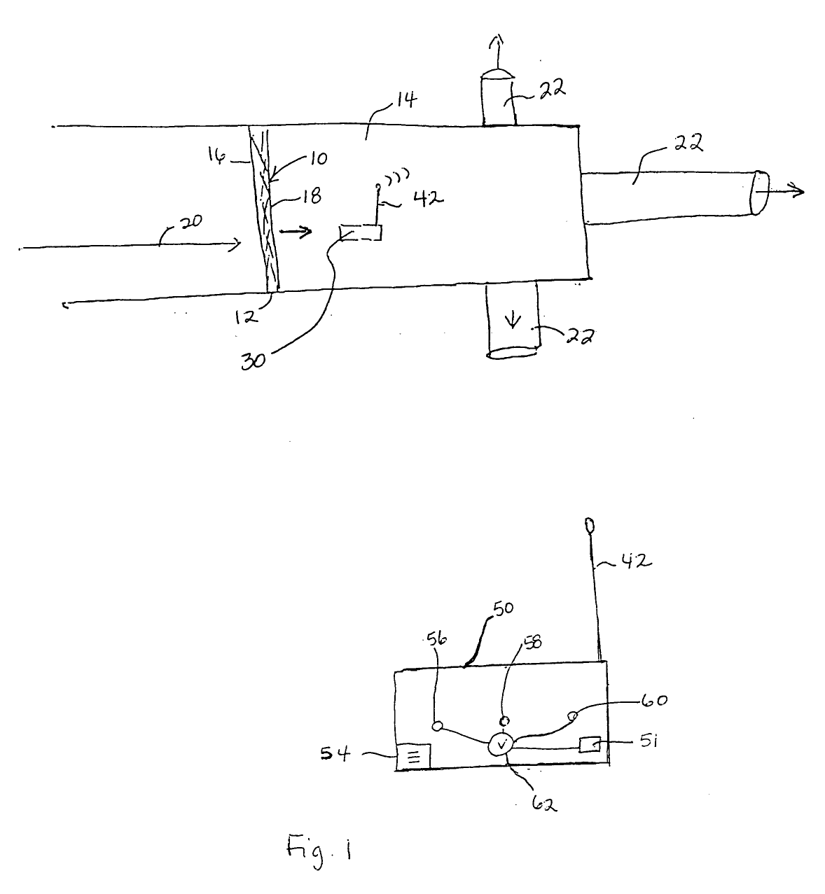

The receiver unit 30 can be equipped with an audio alarm 54 and/or visual alarm members. In the example shown in FIG. 1, the receiver unit 32 is provided with three visual indicators. A visual indicator 56 which can be a green color LED is illuminated when the air filter 10 is not clogged in any manner. The visual indicator 58, which can be a yellow color LED, will indicate to the technician or homeowner that the air filter is somewhat clogged and change of the filter is necessary. An optional third light 60, which can be a red color LED is illuminated when the flow on the downstream side 18 of the filter 10 is significantly reduced and there exists the danger of overheating the motor.

The audio warning member 54 can generate a buzz or a whistle that, along with the LED light members 56, 58 and 60 can provide the warning signal to the technician located a distance from the sensor unit 30. The audio member, as well as the visual warning members 56, 58, and 60 are connected to a battery 62 positioned within the receiver housing unit 50. It is envisioned that the audio warning unit 54, as well as the illuminated unit 56, 58 and 60 operate contemporaneously giving the visual and audible signals to the homeowner or the technician on the condition of the filter.

The signal transmitted by the antenna 42 of the sensor unit 30 and the antenna 52 of the receiver unit are wireless antennas. The transmitter member 40 and the processor 51 are have wireless capabilities, thereby eliminating the need for additional wiring or a visit from an installation technician when employing the device of the present invention. The receiver unit 32 can be placed in any convenient place for the user, such as a home office, desk, at the thermostat station, computer station, in any room in the house, etc. The receiver unit 32 is transportable within a designated range, for instance 100 to 300 feet within the building. The transmitter unit 30 is positioned in the air duct 14 in any location adjacent to the downstream side 18 of the filter 10.

The present invention can also detect malfunction in the operation of the AC motor of the HVC system by detecting that no airflow passes across the filter 10 when the HVAC system is operational. When there is no flow on the downstream side 18 of the filter 10, the sensor unit 30 will send a warning signal to the receiver unit 32. The processor sends a signal to the audio and visual means to give a warning of a malfunction in the HVAC system.

Many changes and modifications can be made in the design of the present invention without departing from the spirit thereof. I therefore pray that my rights to the present invention be limited only by the scope of the appended claims.

I claim:

1. A warning device for monitoring an air filter condition in an HVAC system, the filter having an upstream side and a downstream side, the device comprising:
a sensor unit mounted adjacent the downstream of the filter, said sensor unit comprising a transmitter; and
a warning means mountable at a selected location at the upstream side of the air filter for processing a signal send by the transmitter and providing a warning signal when conditions on the downstream side of the air filter deviate from a pre-determined range.

2. The device of claim 1, wherein said sensor unit comprises a sensor member operationally connected to the transmitter, said sensor member detecting a condition on the downstream side of the air filter when the amount of air flow passing across the air filter falls below a pre-determined value.

3. The device of claim 2, further comprising a flapper member operationally connected to the sensor, said flapper member contacting a trigger switch for sending a signal to the transmitter when the amount of air flow passing across the air filter falls below a pre-determined value.

4. The device of claim 1, wherein said sensor unit comprises a sensor member operationally connected to the transmitter for detecting a condition on the downstream side of the air filter when pressure differential between the upstream side of the air filter and the downstream side of the filter exceeds a predetermined value.

5. The device of claim 3, wherein said sensor member comprises a pressure switch for detecting out-of-norm pressure differential between the upstream side and the downstream side of the air filter.

6. The device of claim 1, wherein said sensor unit further comprises an antenna operationally connected to the transmitter for wirelessly transmitting the signal indicative of the condition on the downstream side of the air filter.

7. The device of claim 1, wherein said warning means comprises a processor for processing the signal received from the transmitter and generating a signal indicative of the condition on the downstream side of the air filter.

8. The device of claim 1, wherein said warning means comprises at least one light emitting member.

9. The device of claim 1, wherein said warning means comprises a plurality of light emitting members and at least one sound emitting member.

10. The device of claim 9, wherein said light emitting members have different color illuminating elements to facilitate differentiating the degree of clogging of the air filter.

11. The device of claim 10, wherein said warning means comprises an antenna operationally connected to the receiver for receiving a signal transmitted by the sensor unit.

12. A warning device for monitoring an air filter condition in an HVAC system, the filter having an upstream side and a downstream side, the device comprising:
a sensor unit mounted adjacent the downstream of the filter, said sensor unit comprising a transmitter and a sensor member; and
a warning means mountable at a selected location at the upstream side of the air filter for providing a warning signal when the air filter becomes clogged, said warning means comprising a receiver for processing a signal sent by the transmitter and audio/visual members operationally connected to the receiver for providing audio and visual indication of the condition on the downstream side of the filter.

13. The device of claim 12, wherein said sensor member for detecting a condition on the downstream side of the air filter when the amount of air flow passing across the air filter falls below a pre-determined value.

14. The device of claim 13, further comprising a flapper member operationally connected to the sensor, said flapper member contacting a trigger switch for sending a signal to the transmitter when the amount of air flow passing across the air filter falls below a pre-determined value.

15. The device of claim 12, wherein said sensor member comprises a pressure switch for detecting out-of-norm pressure differential between the upstream side and the downstream side of the air filter.

16. The device of claim 12, wherein said sensor unit further comprises an antenna operationally connected to the transmitter for wirelessly transmitting the signal indicative of the condition of the air filter.

17. The device of claim 12, wherein said visual members comprise a plurality of light emitting members, said light emitting members having different color illuminating elements to facilitate differentiating the degree of clogging of the air filter.

18. The device of claim 16, wherein said warning means further comprises an antenna operationally connected to the receiver for receiving a signal transmitted by the sensor unit.
